(19) United States
(12) Patent Application Publication
(10) Pub. No.: US 2004/0159604 A1
(43) Pub. Date: Aug. 19, 2004

(54) Fluid filter

(75) Inventor: Jaime Fuentes, Berwyn, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Filtertec Services, Inc.

(21) Appl. No.: 10/366,887

(22) Filed: Feb. 14, 2003

(51) Int. Cl. B01D 35/34

(52) U.S. Cl. 210/435

(57) ABSTRACT

A fluid filter having a housing assembly defining a chamber through which fluid to be filtered can flow. The housing assembly has a fluid outlet and a fluid inlet. A filtering assembly is provided within the chamber through which fluid moving between the fluid inlet and fluid outlet passes. The housing assembly has an opening through which at least a part of the filtering assembly can be directed into an operative position within the chamber. The cover assembly selectively seals the opening and allows access to the filtering assembly therethrough. The cover assembly has a cover element and a cover locking assembly. The cover locking assembly has a locked state and a released state. The cover locking assembly draws the cover element against the housing assembly along a first line with the cover locking assembly in the locked state. The cover locking assembly has a securing knob that is drawn against the cover assembly to bear the cover assembly forcibly against the housing assembly with the cover locking assembly in the locked state. The securing knob has a first surface that wedges relative to a cooperating surface on the cover assembly with the cover locking assembly in the locked state.

### BACKGROUND OF THE INVENTION

1. Field of the Invention

This invention relates to filters and, more particularly, to a filter for separating impurities from a fluid.

2. Background Art

Fluid filters are used in a wide range of environments. One conventional construction has a housing defining a chamber in which a filtering element is disposed. The housing defines an access opening in communication with the filter chamber. It is known to use overcenter clamp mechanisms to draw a cover element to a closed position on the housing wherein the cover element seals the access opening. Typically, an adjustable knob is provided on a rod and has a surface which is borne by the clamp mechanisms against a cooperating surface on the cover assembly. Heretofore, the cooperating surfaces have been substantially flat surfaces, the planes of which are substantially orthogonal to the direction of force application to the cover assembly. Since a plurality of the clamp assemblies are normally incorporated and each independently adjustable, a certain amount of skewing of the cover assembly may result as the clamp assemblies are locked. This may preclude the desired face-to-face contact between the cooperating surfaces on all of the clamp assemblies as would securely hold down the cover assembly. The cover element may then be prone to shifting and/or rattling with a fluid flowing through the filter under pressure.

### SUMMARY OF THE INVENTION

In one form, the invention is directed to a fluid filter having a housing assembly defining a chamber through which fluid to be filtered can flow. The housing assembly has a fluid outlet and a fluid inlet. A filtering assembly is provided within the chamber through which fluid moving between the fluid inlet and fluid outlet passes. The housing assembly has an opening through which at least a part of the filtering assembly can be directed into an operative position within the chamber. The cover assembly selectively seals the opening and allows access to the filtering assembly therethrough. The cover assembly has a cover element and a cover locking assembly. The cover locking assembly has a locked state and a released state. The cover locking assembly draws the cover element against the housing assembly along a first line with the cover locking assembly in the locked state. The cover locking assembly has a securing knob that is drawn against the cover assembly to bear the cover assembly forcibly against the housing assembly with the cover locking assembly in the locked state. The securing knob has a first surface that wedges relative to a cooperating surface on the cover assembly with the cover locking assembly in the locked state.

In one form, the first surface of the securing knob is at an angle to the first line.

The cooperating surface on the cover assembly may be at an angle to the first line.

In one form, the cooperating surface on the cover assembly is defined by a washer.

The cover element may have a counterbore that receives the washer.

In one form, the cover element is made from a non-metal material.

In one form, the counterbore is bounded by a non-metal material and the washer is made from a metal material.

In one form, the securing knob has a tapered cylindrical shape defining the first surface.

The cooperating surface may be defined by a tapered cylindrical shape.

In one form, the cover locking assembly has an overcenter clamp mechanism with a rod to which the securing knob is attached. The overcenter clamp mechanism has an overcenter locked state with the cover locking assembly in its locked state.

In one form, the rod has a length, with the securing knob being adjustable along the length of the rod.

The rod and securing knob may be threadably engaged with each other to allow the adjustment.

In one form, the cover element has a central axis and a slot which opens radially relative to the central axis, with the rod residing within the slot.

In one form, the housing assembly has an annular shoulder. The cover locking assembly has a band which extends around the housing assembly. The band bears against the annular shoulder such that the annular shoulder and cover element are captive between the band and the securing knob.

In one form, the housing assembly is made from a non-metal material.

In one form, the annular shoulder has a diameter. The band has an edge and a variable diameter to allow the band to be configured selectively into (a) a first configuration wherein the edge has a diameter greater than the diameter of the annular shoulder and (b) a second configuration wherein the edge has a diameter to axially engage the annular shoulder fully around the annular shoulder.

In one form, the cooperating surface on the cover assembly is defined by a washer which has a slot that coincides with the slot in the cover element.

The securing knob may be part of an overcenter clamp mechanism attached to the band.

In one form, there are a plurality of overcenter clamp mechanisms attached to the band. Three to six such overcenter clamp mechanisms may be attached to the band.

In one form, a plurality of the overcenter clamp mechanisms have substantially the same construction.

At least one of the securing knob, the washer and the band may be made from a stainless steel material.

### BRIEF DESCRIPTION OF THE DRAWINGS

FIG. 1 is an exploded, elevation view of a fluid filter, according to the present invention, and consisting of a housing assembly defining a chamber through which filtering fluid passes, a filtering assembly within the chamber, a mounting base for supporting the housing assembly, and a cover assembly for closing an opening communication with the chamber and through which the filtering assembly within the chamber is accessed;

FIG. 2 is a view as in FIG. 1 with the fluid filter in an operative state;

FIG. 3 is a cross-sectional view of a part of the fluid filter of FIGS. 1 and 2, with the components in an operative state and with the mounting base and a portion of the cover assembly removed;

FIG. 4 is an enlarged, elevation view of the housing assembly on the fluid filter of FIGS. 1-3;

FIG. 5 is an enlarged, cross-sectional view of a portion of the housing assembly within the circle in FIG. 4;

FIG. 6 is an enlarged, plan view of a bottom wall on the filtering assembly on the fluid filter of FIGS. 1-3;

FIG. 7 is a cross-sectional view of the bottom wall on the filtering assembly taken along line 7-7 of FIG. 6;

FIG. 8 is an enlarged, plan view of a reinforcing/spacing ring at the upper region of the filtering assembly shown in FIGS. 1-3;

FIG. 9 is a cross-sectional view of the reinforcing/spacing ring taken along line 9-9 of FIG. 8;

FIG. 10 is an enlarged, bottom view of a cover plate on the cover assembly on the fluid filter of FIGS. 1-3;

FIG. 11 is an enlarged, elevation view of the cover plate in FIG. 10;

FIG. 12 is an enlarged, plan view of a base plate on the housing assembly on the fluid filter of FIGS. 1-3;

FIG. 13 is an enlarged, elevation view of the base plate in FIG. 12;

FIG. 14 is an enlarged, plan view of a locking assembly for the cover plate in FIGS. 10 and 11 and including a plurality of draw-type clamp mechanisms.

FIG. 15 is an enlarged, elevation view of one of the clamp mechanisms on the locking assembly of FIG. 14;

FIG. 16 is an enlarged, elevation view of a locking knob on each clamp mechanism that bears upon the cover plate;

FIG. 17 is an enlarged, bottom view of the locking knob in FIG. 16;

FIG. 18 is an enlarged, plan view of a washer that is interposed between the locking knob in FIGS. 16 and 17 and the cover plate in FIGS. 10 and 11;

FIG. 19 is a cross-sectional view of the washer taken along line 19-19 of FIG. 18; and

FIG. 20 is an enlarged, elevation view of the washer taken from the right side in FIG. 18.

### DETAILED DESCRIPTION OF THE DRAWINGS

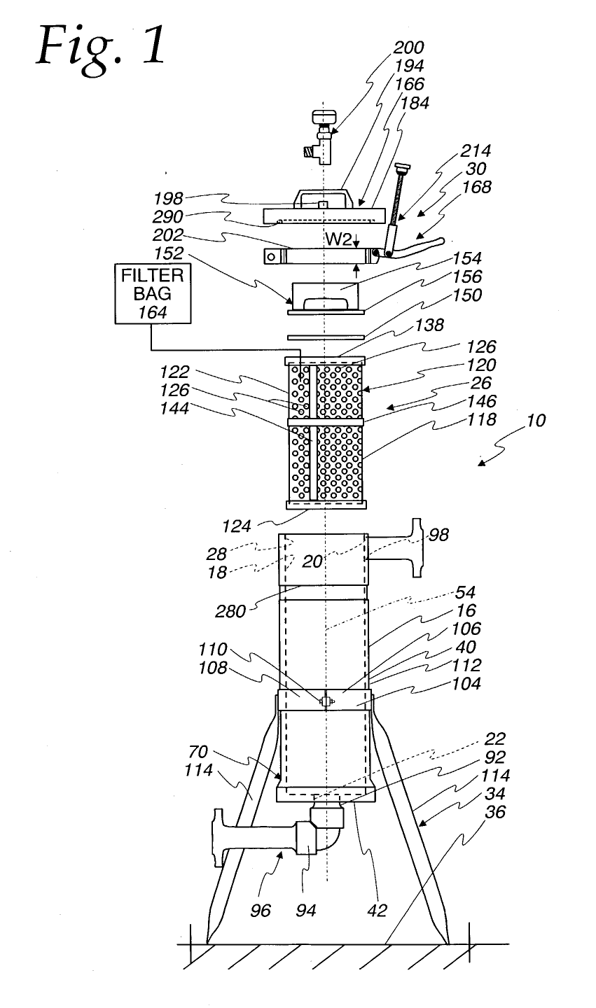

Referring initially to FIGS. 1-3, a fluid filter, according to the present invention, is shown at 10. The fluid filter 10 is designed for use in virtually any environment in which fluid flows between a supply 12 and a point of use 14. The fluid filter 10 can be used for: polishing slurries; processing water and plating solutions in the metal plating industry; household and municipal water supplies; pre-filtering for desalination in the consumer market; compositions in the chemical industry; processing water and plating solutions in the electronics industry; magnetic coatings in the audio, video, computer tape, and computer hard disks industry; refiltration for industrial water supplies, etc. The above are just examples of myriad different potential applications for the filter 10, as described below. Further, the fluid filter 10 can be used by itself or in combination with other like, or different, filters.

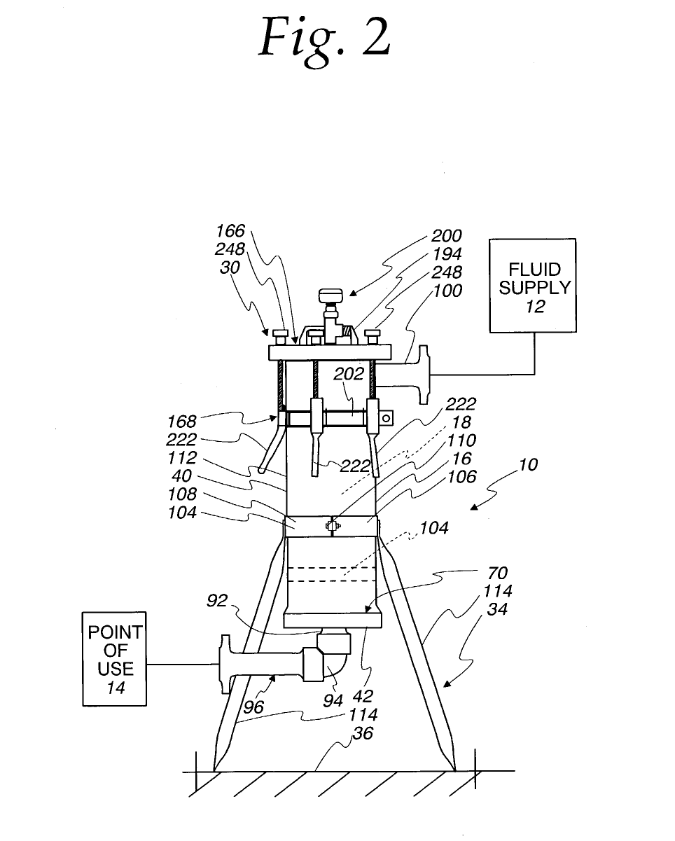

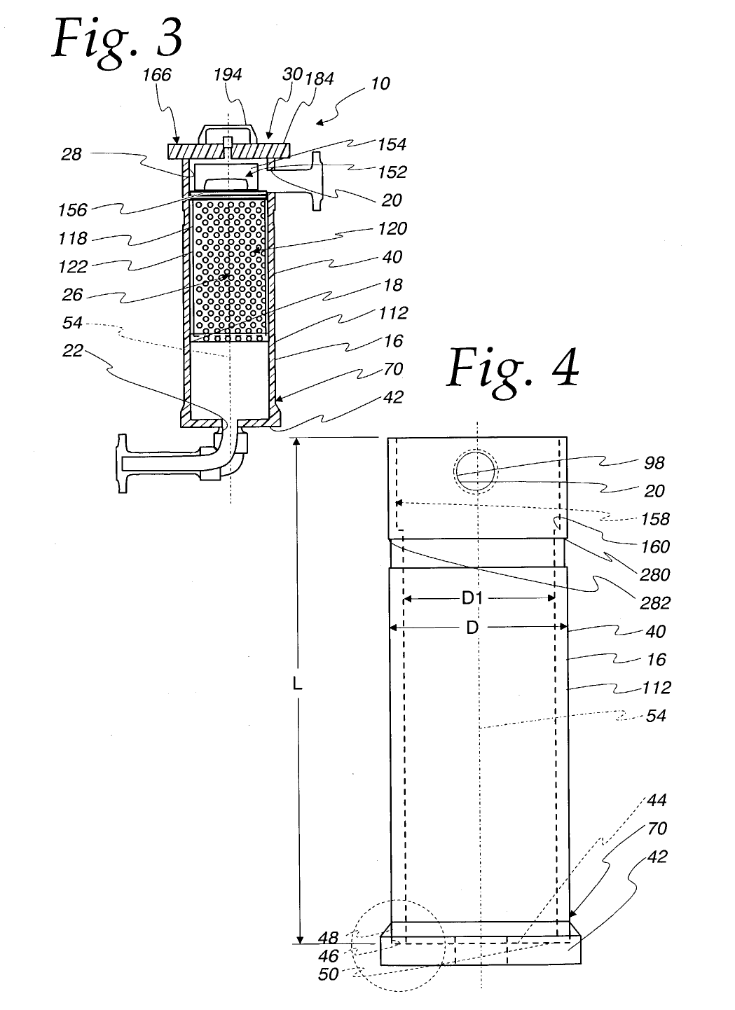

The fluid filter 10 consists of a housing assembly 16 defining a chamber 18 through which fluid to be filtered can flow between a fluid inlet 20 and a fluid outlet 22. A filtering assembly at 26 resides at least partially within the chamber 18. The filtering fluid moves through the filtering assembly in its flow path between the fluid inlet 20 and fluid outlet 22. The housing assembly has an opening 28 through which at least a part of the filtering assembly 26 can be directed into an operative position within the chamber 18, as shown in FIGS. 2 and 3. The cover assembly at 30 selectively seals the opening 28 and exposes the same to allow the filtering assembly 26 to be accessed, as to be introduced and withdrawn from the chamber 18. A mounting base at 34 supports the housing assembly 16 relative to a surface 36 upon which the fluid filter 10 is mounted.

As seen additional in FIGS. 4, 5, 12 and 13, the housing assembly consists of a cylindrical housing body 40 to which a base plate 42 is attached. The housing body 40 may be made from cylindrical pipe stock with an outside diameter D and inside diameter D1. The stock material can be cut to the desired vertical length L.

The base plate 42 may be formed from a disk-shaped block having a diameter D3 and a thickness T. The diameter D3 is greater than the diameter D and allows the formation of a cylindrical undercut 44, having a diameter D4, that is slightly greater than the diameter D and having an axial extent identified by the dimension T1. The undercut 44 defines a cylindrical surface portion 46 which closely surrounds an annular surface portion 48 adjacent to the bottom, free, annular edge 50 on the housing body 40. With the housing body 40 and base plate 42 operatively connected, the portions 46,48 cooperate by residing, one with the other, to produce an exposed, annular seam 52 extending fully around the central axis 54 of the housing body 40 and a coincident central axis 56 of the base plate 42.

According to the invention, the housing body 40 and base plate 42 are maintained operatively connected by the combination of at least one weld and a plurality of mechanical fasteners. The housing body 40 and base plate 42 are preferably, though not necessarily, made from a non-metal material. At least the cooperating portions 46,48 are preferably made from such non-metal material. The non-metal material may be plastic. Exemplary, suitable plastics for this purpose are at least one, or a combination of: polyvinyl chloride (PVC); (b) polypropylene (PP); (c) chlorinated polyvinyl chloride (CPVC); and (d) polyvinylidene fluoride (PVDF).

As seen most clearly in FIG. 5, once the housing body 40 and base plate 42 are operatively connected, a first weld 58 is formed continuously therearound, as by the use of a natural polypropylene triangle weld rod, that is initially separate from the housing body 40 and base plate 42. After the first weld 58 is completed, a second weld 60 is formed thereover, as by using a straight Teflon® shoe from an extrusion welder. The welding material may be the same as, or different than, the material defining the cooperating portions 46,48.

The mechanical fasteners, used in conjunction with the welds 58,60 to maintain the operative connection between the housing body 40 and base plate 42, are shown as self-tapping, threaded bolts 68, as seen in FIG. 5. The bottom axial end 70 of the housing body 40 is pre-drilled to accommodate the bolts 68. More particularly, blind bores 72 are formed through the annular edge 50 to a depth L1. The bores 72 are preferably spaced equidistantly around the circumferential extent of the edge 50. Five to ten such bores 72 are formed to accommodate a like number of bolts 68. However in the form shown, eight such bores 72 and fasteners 68 are utilized. Preferably, the circumferential intervals between the bores 72 and bolts 68 are substantially equal, though they need not be.

The base plate 42 has a plurality of stepped, through bores 76 formed therein, with each including a larger diameter portion 78 and a smaller diameter portion 80. The through bores 76 in the base plate 42 preferably correspond in number and are aligned, one each, with the blind bores 72 formed in the housing body 40.

The fasteners 68 each have an enlarged head 82 that has a polygonal shape, to be turned by a conventional wrench, and a threaded shank 84. With the housing body 40 and base plate 42 operatively connected, the bolts 68 can be directly initially through the through bores 76 and into the bores 72 in the housing body 40. As the bolts 68 are tightened, the enlarged heads 82 move fully into the larger diameter portions 78 of the through bores 76 to against annular shoulders 86 so as to be countersunk within the bores 76.

To assure sealing of the chamber 18, the fasteners 68 can be installed using equipment that effects a spin-welding connection between the enlarged heads 82 and the cooperating shoulders 86 bounding the larger diameter portions 78 of the through bores 76. The larger diameter portions 78 can be filled by a sealing material 88.

In one exemplary construction, the diameter (D) of the housing body 40 is 8.625 inches, with the base plate 42 having a diameter (D3) of 9.5 inches and a thickness (T) of 1.5 inches. The undercut 44 is made to an axial depth (T1) of 0.5 inches. The bores 76 are drilled through the base plate 42 with a diameter of 0.281 inches. The larger diameter portions 78 are drilled to a diameter of 0.75 inches and to a depth of 0.625 inches. The fasteners 68 are 0.312 inches-18×1.5 inches long 316 stainless steel hex head bolts that are spin-welded using an impact wrench. The sealing material 88 may be extrusion weld natural polypropylene. The first weld may be formed with a 0.175 natural polypropylene triangular weld rod, with the second weld 60 made over the first weld 58 with a #6-bead straight Teflon® shoe from an extrusion welder. The final bead may measure 0.75×0.75×0.875 inches. It should be understood that these dimensions are set out simply to describe one specific embodiment without any limitations intended thereby. The dimensions of all the component parts could be significantly larger or smaller, as the particular application dictates.

The base plate 42 defines the fluid outlet 22. More specifically, a bore 90 is formed through the center of the base plate 42 and is threaded to accommodate a nipple 92, which in turn connects to an elbow 94 for direction of the filtered fluid to the point of use 14. An exemplary diameter for the bore 90 is on the order of 2 inches, with the other above-described dimensions. The particular direction and extent of the conduit 96 extending from the fluid outlet 22 are not important to the present invention.

A like bore 98 is formed through the upper axial end of the housing body 40 to define the fluid inlet 20. The bore 98 may have the same diameter as the bore 90 and is threaded to facilitate connection of a conduit 100. The bore 98 defines the fluid inlet 20 through the housing body 40.

The mounting base 34 consists of a mounting strap 104 defined by arcuate parts 106,108 which are joinable by bolts 110 (one shown) so as to cooperatively surround and embrace the outer surface 112 of the housing body 40. The mounting strap 104 has a conventional construction which allows the diameter to be enlarged to facilitate sliding axially along the outer surface 112 of the housing body 40. By tightening the bolts 110, the effective diameter of the strap 104 can be reduced and the desired axial location of the mounting strap 104 thereby maintained. The vertical strap location determines the mounting height for the housing body 40 relative to the subjacent surface 36. It should also be noted that while the mounting strap 104 is defined as having separate arcuate parts, it could be constructed from a single split ring assembly as used on the cover assembly 30, as hereinafter described.

Mounting legs 114 are fixed to the mounting strap 104 in a tripod arrangement. Additional mounting legs 114 might be utilized. Accordingly, at initial setup, the installer can loosen the bolts 110 and slide the mounting base 34 to the desired axial height, and thereafter tighten the bolts 110 to fix the desired relationship between the mounting base 34 and the housing body 40. As seen in FIG. 2, by moving the mounting strap 104 to the dotted line position, the height of the housing body relative to the support surface 36 is increased. The adjustment range is determined by the axial extent of the outer surface 112 of the housing body 40 with a substantially uniform diameter.

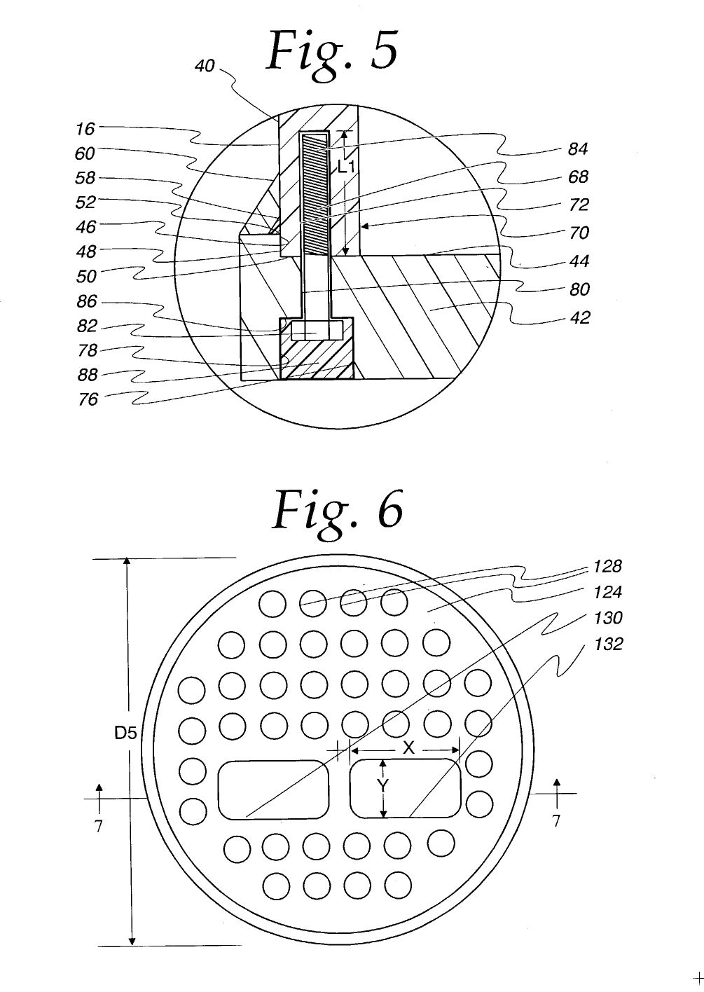

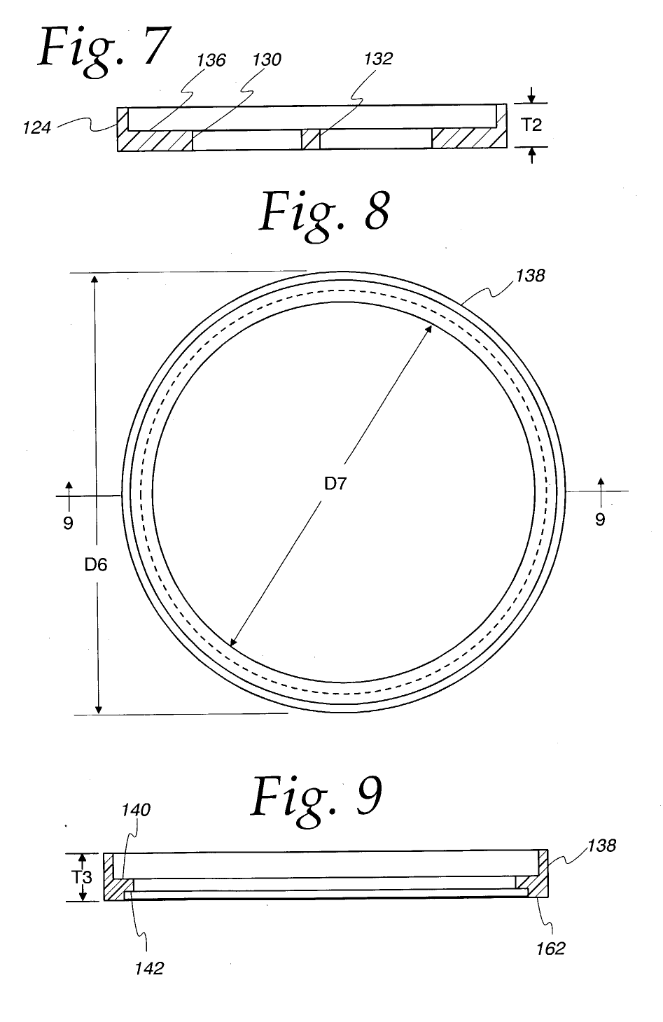

The filtering assembly 26 is shown as a filter bag-type system. However, the invention is not limited to such a design. The filtering assembly 26 consists of a cup-shaped basket assembly 118 as seen most clearly in FIGS. 1, 3 and 6-9. The basket assembly 118 has a wall structure 120 consisting of a cylindrical peripheral wall 122 and a disk-shaped bottom wall 124. The peripheral wall 122 is formed from a sheet, such as one made from natural polypropylene. As one example, the sheet may have a thickness of 0.125 inches, a width of 13.25 inches, and a length of 21 inches. With these dimensions, 35 rows of 0.5 inch diameter-holes 126 are formed, with the holes 126 spaced on 1.125 inch centers, and with each row offset 0.562 inches.

The bottom wall 125 can likewise be made from a polypropylene material, having a diameter D5 that may be on the order 7.25 inches, with a thickness T2 on the order 0.75 inches. The bottom wall has eight rows of holes 128, which may be spaced on 0.75 inch centers and each have a diameter on the order 0.5 inches. Spaced, rectangular slots 130,132 are formed through the bottom wall 124 and have an exemplary longer dimension X of 2.05 inches and a shorter dimension Y on the order 1.125 inches. The bottom wall 124 has an annular undercut 136 to receive the peripheral wall 122.

A top ring 138 may likewise be made from a polypropylene material with a thickness T3 on the order of 0.75 inches and an outside diameter D6 on the order of 7.665 inches and an inner diameter D7 on the order of 6.625 inches. The upper portion of the top ring 138 has an annular undercut 140, with the underside having an undercut 142, with the former having a larger diameter.

The sheet defining the peripheral wall 122 is rolled into a cylindrical shape and welded at its ends and thereafter to a reinforcing strip 144 extending axially along the length thereof. A weld may be produced along the entire length of the reinforcing strip 144 at its circumferentially spaced edges. The opposite axial ends of the peripheral wall 122 are then placed in the undercuts 136,142 in the bottom wall 124 and top ring 138, respectively, and welded thereto.

An intermediate ring 146 is welded to the outside of the peripheral wall approximately midway between the bottom wall 124 and top ring 138. The bottom wall 124, top ring 138 and intermediate ring 146 cooperatively reinforce the peripheral wall 122 and perform a spacing function between the basket assembly 118 and the housing body 40.

An O-ring 150 is placed in the undercut 140 in the top ring 138. A filter lock assembly 152, consisting of a handle 154 and integral locking ring 156, cooperates with the housing body 40 in conventional fashion. The upper region of the chamber 18 has a localized increased diameter 158 which defines an annular, axially facing shoulder 160 on the housing body 40 against which the underside edge 162 of the top ring 138 bears with the filtering assembly 26 operatively positioned relative to the housing assembly 16.

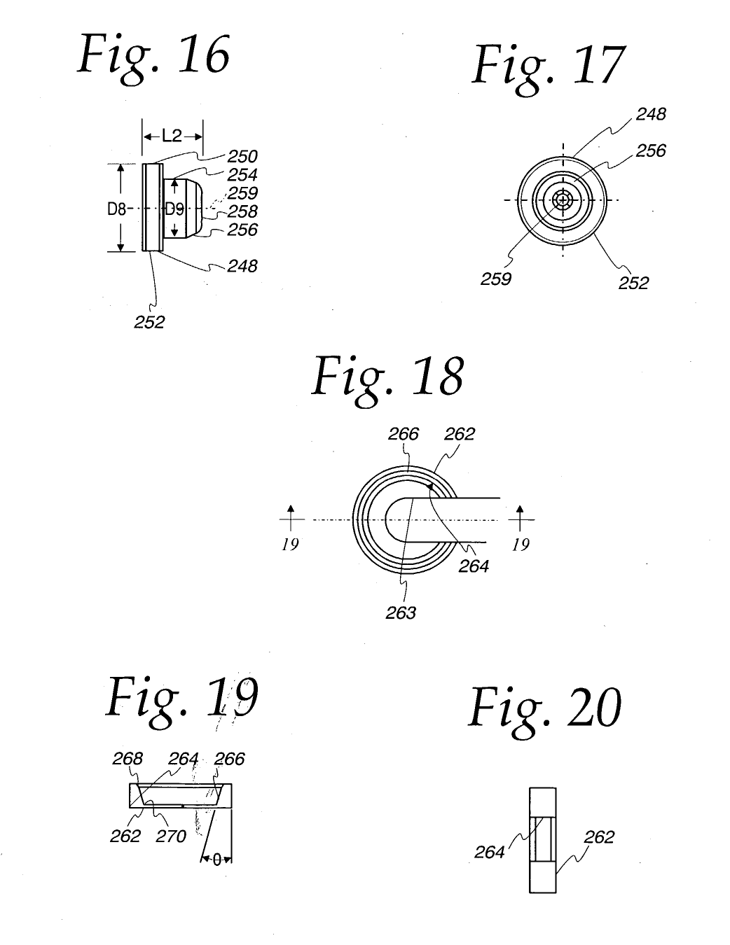

Once the basket assembly 118 is installed, the appropriate filter bag 164 can be put in place after which the filter lock assembly 152 is installed. Thereafter, the cover assembly 30 is installed. The cover assembly 30 consists of a cover element 166, as shown in FIGS. 1-3, 10 and 11, and a cover locking assembly 168, as shown in FIGS. 1, 2 and 14-19. The cover element 166 has a disk shape with a diameter D8 and thickness T4. As one example, the cover element 166 can be made from a natural polypropylene with a diameter D8 on the order of 12 inches and a thickness T4 on the order of 1.5 inches.

The underside 170 has an annular groove 172 formed therein. Five radially outwardly opening, U-shaped slots 174 are formed through the peripheral edge 176. The slots 174 are spaced equidistantly around the peripheral edge 176. Each slot 174 has a U-shaped base 178 defined by a constant radius on a center 180. Counterbores 182 are formed partially through the top side 184 of the cover element 166 so that the centers of the counterbores 182 are coincident with the centers 180. An exemplary radius for the base 178, and thus the width W of each slot 174, may be on the order of 0.562 inches.

Bores 186,188 are formed equally spaced at diametrically opposite locations from the center 190 of the cover element 166. The bores 186,188 are threaded to each accept a fastener 192, which is threadedly engaged with a U-shaped handle 194. The handle 194 is graspable to facilitate manipulation of the cover element 166.

The cover element 166 has a through bore 196, on the order of one half inch in diameter, which is threaded to receive a nipple 198, to accept a pressure gauge/air release assembly 200.

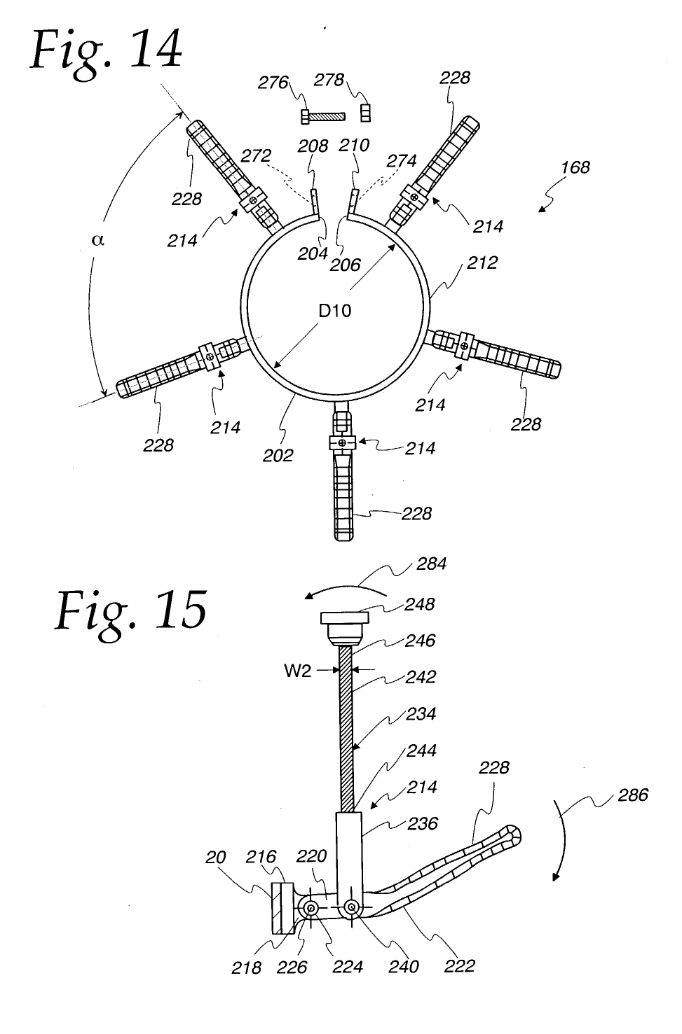

The cover element 166 is maintained on the housing body, so as to close the opening 28, by a cover locking assembly 168. The cover locking assembly 168 consists of a band 202 having a width W2 that may be on the order 1.5 inches. The band 202 has a length sufficient to extend around the outer surface 112 of the housing body 40. The band 202 is formed into a circular shape, shown in FIG. 14, with adjacent, spaced ends 204,206. Bolt plates 208,210 are welded to the band 202 at the ends 204,106, respectively, so as to project substantially orthogonally from the outer surface 212 of the band 202.

A plurality, and in this embodiment five, draw-type clamp mechanisms 214, each of like construction, are welded to the outer surface 212 so as to be equidistantly spaced around the circumference thereof. In the case of the five clamp mechanisms 214 shown, the centers of each clamp mechanism 214 are spaced from adjacent clamp mechanisms 214 by an angle α, which is on the order of 72°.

Each clamp mechanism 214 consists of a base 216, which is welded to the band outer surface 212. Each base 216 has a projection 218 which is straddled by a bifurcated end 220 of a bent draw handle 222. The bifurcated end 220 and projection 218 are connected by a pin 224 which guides pivoting movement between the end 220 of the draw handle 222 and the projection 218 about an axis 226. The draw handle 222 has an elongate, graspable portion 228, remote from the end 220, which facilitates pivoting of the draw handle 222 about the axis 226.

An adjustable draw rod 234 has a base end 236 connected to the draw handle 222, at a location intermediate the ends thereof, for pivoting movement relative to the draw handle 222 about an axis 240, that is substantially parallel to the axis 226. The effective length of the draw rod 234 is varied by oppositely rotating a threaded rod 242 relative to the base end 236. One end 244 of the rod 242 is threaded into the base end 236, with the opposite end 246 threadably connected to a securing/locking knob 248. The securing knob 248 has a stepped outer diameter. Each securing knob 248 may have a diameter D8 on the order 1.5 inches and an axial length L2 on the order of one inch. Each securing knob 248 has an outer diameter portion 250 which is knurled to facilitate grasping and turning thereof. The outer surface 252 steps down to a uniform diameter portion 254 having a diameter (D9) on the order of one inch. The outer surface has a bevel 256 adjacent to the end 258. The angle of the bevel may be on the order of 17° relative to the central axis 259 of the knob 248 but may vary over a significant range.

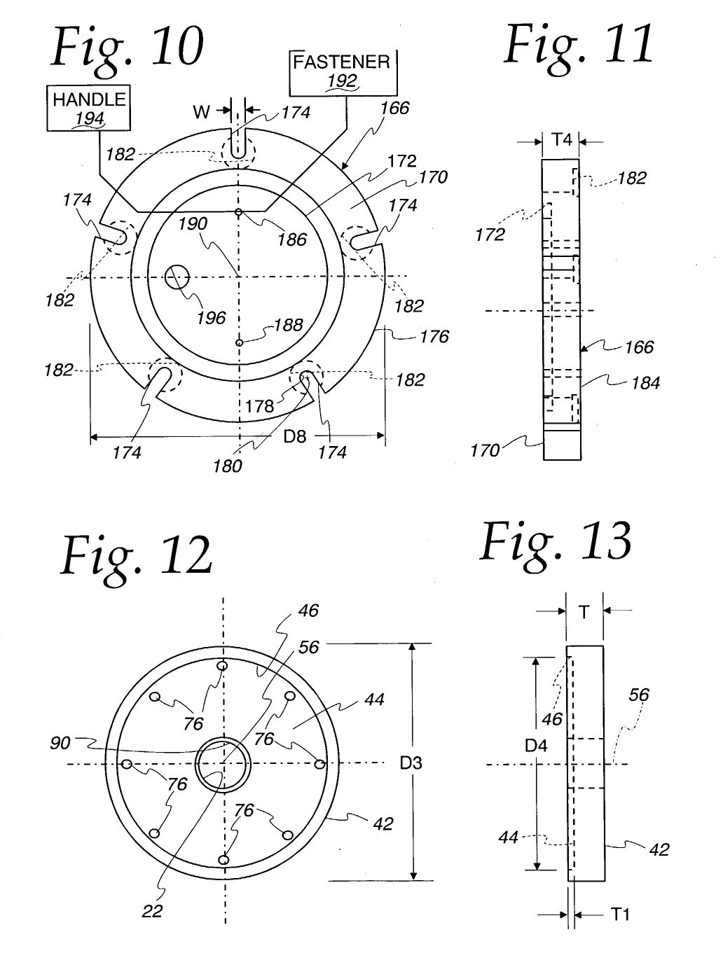

C-shaped washers 262 are disposed, one each, in the counterbores 182 (FIG. 10) on the top side 184 of the cover element 166. The washers 162 have slots 264 corresponding in shape and size to the slots 174, which have a width W sufficient to loosely accept the width W2 of the threaded rods 242. The washers 162 have a receptacle 264 to receive the outer surface 252 of the securing knobs 248. The receptacle 264 is bounded by a surface 266 that tapers progressively from the top 268 to the bottom 270 of the receptacle 264 at an angle θ to vertical. The angle θ may be on the order of 40°, but may vary over a significant range.

The bolt plates 208,210 have through bores 272,274, respectively, to accept a bolt 276. The bolt 276 is directed through the bolt plates 208,210 and receives a nut 278. By tightening the nut 278, the bolt plates 208,210 are drawn towards each other to thereby effectively reduce the inside diameter D10 of the band 202 from a first diameter that loosely surrounds the housing body 40. The band 202 is dimensioned to be reducible to a second diameter to reside within an annular undercut 280 (FIG. 4) in the outer surface 112 of the housing body 40. The undercut 280 defines an annular, downwardly facing shoulder 282 against which the band 202 can be braced, around its full circumferential extent, as the cover locking assembly 168 is installed. With the band 202 tightened securely to the housing body 40 within the undercut 280, and the clamp mechanism 214 in a released state, as shown in FIG. 1, each of the draw rods 234 can be pivoted in the direction of the arrow 284 about its associated axis 240 to move the rods 242 through the slots 174,264 in the cover element 166 and washers 262, respectively. With the lengths of the draw rods vertically aligned, the securing knobs 248 can then be tightened a prescribed amount after which the draw handles 222 are pivoted in the direction of the arrow 286 in FIG. 15 about the axes 226, thereby drawing the securing knobs 248 downwardly against the washers 262. The cooperating surfaces 252,266 on the securing knobs 248 and washers 162, by reason of being angled, produce a wedging action between the securing knobs 248 and washers 162 that causes a consistent interaction of these elements that avoids relative horizontal shifting therebetween as might compromise the sealing of the chamber 18. The pivoting of the draw handles 222 continues until an overcenter locked position is realized, as shown in FIG. 2, so that a constant vertical force is maintained through the downwardly urged knobs 248 upon the cover element 166 against the housing body 40. A lid gasket 290 (FIG. 1) is provided to effect a positive seal between the cover element 166 and housing body 40. With all of the clamp mechanisms 214 in the locked state, the cover locking assembly 168 is in its locked state with the annular shoulder 282 and cover element 166 captive between the band 202 and the securing knobs 248.

With the inventive structure, fluids can be filtered at a relatively high pressure and volume without leakage. Safeguards may be employed to prevent leakage at all connections, such as at the fluid outlet 222 for the conduit 96. For example, the connection between the nipple 92 to the elbow 94, shown in FIG. 1, can be bottomed out and then welded in one or more separate operations, as at all the threaded connections. Teflon® tape can also be used at all threaded connections.

All of the mechanical fasteners that are exposed to the fluid can be made from a non-metal material. Accordingly, no metal part of the fluid filter 10 need be exposed directly to the fluid. The metal parts utilized throughout can be made from stainless steel so as to have good integrity and strength as well as good resistance to degradation in the presence of the various fluids being filtered.

While the invention has been described with particular reference to the drawings, it should be understood that various modifications could be made without departing from the spirit and scope of the present invention.

1. A fluid filter comprising:
a housing assembly defining a chamber through which fluid to be filtered can flow,
the housing assembly having a fluid inlet and a fluid outlet;
a filtering assembly within the chamber through which fluid moving between the fluid inlet and fluid outlet passes,
the housing assembly having an opening through which at least a part of the filter assembly can be directed into an operative position within the chamber; and
a cover assembly for selectively sealing the opening and allowing access to the filtering assembly therethrough,
the cover assembly comprising a cover element and a cover locking assembly,
the cover locking assembly having a locked state and a released state,
the cover locking assembly drawing the cover element against the housing assembly along a first line with the cover locking assembly in the locked state,
the cover locking assembly comprising a securing knob that is drawn against the cover assembly to bear the cover assembly forcibly against the housing assembly with the cover locking assembly in the locked state,
wherein the securing knob has a first surface that wedges relative to a cooperating surface on the cover assembly with the cover locking assembly in the locked state.

2. The fluid filter according to claim 1 wherein the first surface of the securing knob is at an angle to the first line.

3. The fluid filter according to claim 2 wherein the cooperating surface on the cover assembly is at an angle to the first line.

4. The fluid filter according to claim 1 where the cooperating surface on the cover assembly is defined by a washer.

5. The fluid filter according to claim 4 wherein the cover element has a counterbore that receives the washer.

6. The fluid filter according to claim 5 wherein the cover element comprises a non-metal material.

7. The fluid filter according to claim 6 wherein the counterbore is bounded by the non-metal material and the washer comprises a metal material.

8. The fluid filter according to claim 1 wherein the securing knob has a tapered cylindrical shape defining the first surface.

9. The fluid filter according to claim 8 wherein the cooperating surface is defined by a tapered cylindrical shape.

10. The fluid filter according to claim 1 wherein the cover locking assembly comprises an overcenter clamp mechanism with a rod to which the securing knob is attached and the overcenter clamp mechanism is in an overcenter locked state with the cover locking assembly in its locked state.

11. The fluid filter according to claim 10 wherein the rod has a length and the securing knob is adjustable along the length of the rod.

12. The fluid filter according to claim 11 wherein the rod and securing knob are threadably engaged with each other.

13. The fluid filter according to claim 10 wherein the cover element has a central axis and a slot which opens radially relative to the central axis and the rod resides within the slot.

14. The fluid filter according to claim 1 wherein the housing assembly has an annular shoulder, the cover locking assembly comprises a band which extends around the housing assembly, and the band bears against the annular shoulder such that the annular shoulder and cover element are captive between the band and the securing knob.

15. The fluid filter according to claim 14 wherein the housing assembly comprises a non-metal material.

16. The fluid filter according to claim 14 wherein the annular shoulder has a diameter, the band has an edge and a variable diameter to allow the band to be configured selectively into (a) a first configuration wherein the edge has a diameter greater than the diameter of the annular shoulder and (b) a second configuration wherein the edge has a diameter to axially engage the annular shoulder fully around the annular shoulder.

17. The fluid filter according to claim 13 wherein the cooperating surface on the cover assembly is defined by a washer and the washer has a slot that coincide with the slot in the cover element.

18. The fluid filter according to claim 14 wherein the securing knob is part of an overcenter clamp assembly attached to the band.

19. The fluid filter according to claim 18 wherein there are a plurality of overcenter clamp mechanisms attached to the band.

20. The fluid filter according to claim 19 wherein there are from 3-6 overcenter clamp assemblies attached to the band.

21. The fluid filter according to claim 20 wherein a plurality of the overcenter clamp mechanisms have substantially the same construction.

22. The fluid filter according to claim 1 wherein the securing knob comprises stainless steel.

23. The fluid filter according to claim 4 wherein the washer comprises stainless steel.

24. The fluid filter according to claim 14 wherein the band comprises stainless steel.
